(19) United States
(12) Patent Application Publication
(10) Pub. No.: US 2026/0312451 A1
(43) Pub. Date: Oct. 8, 2026

(54) STATOR FOR AN ELECTRIC MACHINE AND METHOD FOR PRODUCING A STATOR

(71) Applicant: Schaeffler Technologies AG & Co. KG, Herzogenaurach (DE)

(72) Inventors: Stephan Penner, Bühl (DE); Aurelien Grauss, Mommenheim (FR)

(73) Assignee: Schaeffler Technologies AG & Co. KG, Herzogenaurach (DE)

(21) Appl. No.: 19/478,880

(22) PCT Filed: Mar. 26, 2024
(86) PCT No.: PCT/DE2024/100257

§ 371 Date: Oct. 27, 2025

(30) Foreign Application Priority Data
Apr. 28, 2023 (DE) 10 2023 111 124.8

(51) Int. Cl. H02K 3/24; H02K 3/50; H02K 9/19; H02K 11/25; H02K 15/26

(52) U.S. Cl. CPC H02K 3/24; H02K 3/50; H02K 9/19; H02K 11/25; H02K 15/26; H02K 2203/09

(57) ABSTRACT

A stator including a stator body having a plurality of circumferentially-distributed stator teeth and stator slots formed between the stator teeth and axially extending through the stator body. Electric conductors of a stator winding are arranged which emerge from the stator body at an end face at least forming a winding head. During operation, a cooling fluid is applied to the winding head, and the winding head is enclosed by a housing which seals the winding head relative to surroundings and the stator body. The housing has an annular-disc-like base and cylinder rings extending axially therefrom. At least one of the electric conductors projects from the winding head and is electrically connected to a connection having a threaded bolt which engages through the housing base and a nut or a bolt head of the threaded bolt outside the housing locks the connection with respect to the housing.

### CROSS REFERENCE TO RELATED APPLICATIONS

This application is the United States National Phase of PCT Appln. No. PCT/DE2024/100257 filed Mar. 26, 2024, which claims priority to German Application No. DE 10 2023 111 124.8, filed Apr. 28, 2023, the entire disclosures of which are incorporated by reference herein.

### FIELD OF INVENTION

The present invention relates to a stator for an electric machine, in particular for an electric machine within a drive train of a motor vehicle, including a stator body having a plurality of stator teeth arranged in a distributed manner over the circumference and stator slots formed between the stator teeth and extending in the axial direction through the stator body, wherein in the stator slots electric conductors of a stator winding are arranged, which emerge from the stator body at an end face, at least forming a winding head, wherein during operation of the electric machine, a cooling fluid can be applied to the winding head, and the winding head is enclosed by an annular housing which seals the winding head with respect to the surroundings and to the stator body, wherein the housing has an annular-disc-like base and cylinder rings extending axially out of the base. The invention further relates to a method for producing a stator.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

A detailed description of an electric drive can be found in an article in the German automotive magazine ATZ, volume 63, 05/20 6, pages 360-365 by Erik Schneider, Frank Fickl, Bernd Cebulski and Jens Liebold with the title: Hochintegrativ und Flexibel Elektrische Antriebseinheit für E-Fahrzeuge (Highly Integrative and Flexible Electric Drive Unit for E-Vehicles). This article describes a drive unit for an axle of a vehicle, which includes an electric motor arranged concentrically with respect to a bevel gear differential. Such drive units are also referred to as e-axles.

In addition to purely electrically operated drive trains, hybrid drive trains are also known. Such drive trains of a hybrid vehicle usually include a combination of an internal combustion engine and an electric motor, and enable, for example in urban areas, a purely electric mode of operation while at the same time permitting both sufficient range and availability, in particular when driving cross-country. In addition, it is possible to drive the vehicle simultaneously with the combustion engine and the electric motor in certain operating situations.

For the development of electric machines, in particular electric machines for the above-mentioned hybrid or fully electric motor vehicles or also for wheel hub drives, fundamentally different winding technologies for a stator of an electric machine are known.

Electric machines which have a hollow-cylindrical stator, i.e., are designed as internal rotor machines, and which are configured for use as a traction drive of a motor vehicle often have a stator winding with a rectangular cross-section in order to achieve a high power density. In electric machines intended for driving motor vehicles, the stator windings are therefore typically designed as I-pin or hairpin windings. In this case, for example, substantially I- or U-shaped wire segments are introduced into the stator slots from one end face of the stator and then shaped at an opposite end face of the stator and connected, for example, by welding.

These wire segments are then connected electrically to power electronics via bus bars. The bus bars are punched from copper sheets or partly formed from rectangular wire, for example. In order to connect the bus bars of the stator winding electrically to the bus bars of the power electronics, also referred to as the inverter, a high-voltage terminal is usually positioned in the current flow between the power electronics and one of the winding heads of the stator winding.

High-voltage terminals are now known from the prior art. For example, DE 10 2019 111 825 A1 discloses a stator for an electric machine with such a high-voltage terminal.

Due to the high degree of integration of such electric traction machines for motor vehicles, the dimensioning of high-voltage connections is usually quite complicated. This also poses an increasing challenge in terms of managing the rising thermal loads of high-voltage connections due to ever higher power densities.

In the development of electric machines intended for e-axles or hybrid modules, there is a continuing need to increase their power densities, so the cooling of electric machines required for this is growing in importance. Owing to the necessary cooling capacities, hydraulic fluids such as cooling oils have become established in most concepts for the removal of heat from the thermally loaded regions of an electric machine.

In this context, what is referred to as direct slot cooling and winding head cooling have become known, which use a liquid cooling medium flowing directly around the slots to achieve very effective cooling of the electric conductors and, by subjecting the winding heads to the cooling medium, good heat dissipation from the winding heads. In this case, it is usually necessary to house the corresponding winding heads for guiding the cooling medium. For this reason, the corresponding high-voltage connections must be routed through the housing.

### SUMMARY

The present disclosure provides a stator that has a high power density, a high degree of system integration, and is easy to assemble. The present disclosure also provides an improved method for producing a stator.

The present disclosure includes a stator for an electric machine, in particular for an electric machine within a drive train of a motor vehicle, including a stator body having a plurality of stator teeth arranged in a distributed manner over the circumference and stator slots formed between the stator teeth and extending in the axial direction through the stator body, wherein in the stator slots electric conductors of a stator winding are arranged, which emerge from the stator body at an end face, at least forming a winding head, wherein during operation of the electric machine, a cooling fluid can be applied to the winding head, and the winding head is enclosed by an annular housing which seals the winding head with respect to the surroundings and to the stator body, wherein the housing has an annular-disc-like base and cylinder rings extending axially out of the base, wherein at least one of the electric conductors of the stator winding projects out of the winding head and is connected in an electrically conductive manner to a screw connection, the threaded bolt of which engages through the base of the housing and a nut corresponding to the threaded bolt or a screw head connected on the threaded bolt outside the housing locks the screw connection with respect to the housing in such a way that an electric connecting conductor can be fixed relative to the screw connection and a current path can be established between the connecting conductor and the at least one electric conductor of the stator winding projecting from the winding head.

This has the advantage that a direct fluid cooling can be provided to a thermally highly stressed region within the high-voltage interface, namely the HV connecting elements, such as the bus bar, the electric conductor projecting from the winding head, the threaded bolt and/or the screw head. For this purpose, the cooling fluid present in a fluid-cooled stator is conducted from the region of the winding head cooling to the high-voltage interface and directed directly onto one or more of the HV connecting elements so that the cooling fluid can be applied to these. This allows for highly efficient cooling of the thermally highly stressed HV connection regions, which can contribute to achieving a high power density and reduced losses in the electric machine.

An aspect of the present disclosure is therefore to position the HV connection points for the electric feed system directly in the base of the housing, wherein the housing is placed over the already mounted HV connecting elements, is received by these in a precisely fitting manner and, with the subsequent screwing, forms a stable form-fitting connection between the at least one electric conductor of the stator winding projecting from the winding head and the housing or the connecting conductor in the electrical path.

Such a design requires only very little axial installation space, allowing for the stator to be constructed as a very compact axial design.

The electric conductor projecting from the winding head can be connected to a screw head or bus bar, for example by welding or soldering, in the same working step as the connection of the star points.

The HV connecting elements, such as the bus bar, the electric conductor projecting from the winding head, the threaded bolt and/or the screw head, can be designed with comparatively small conductor cross-sections, since they are largely immersed in the cooling fluid or same is directly applied to it. This also makes it particularly easy and inexpensive to provide the HV connection point.

The HV connecting elements, such as the bus bar, the electric conductor projecting from the winding head, the threaded bolt and/or the screw head, are therefore actively cooled by the cooling fluid and can thus transmit high electrical power densities. It is particularly beneficial that the cooling fluid can be directly applied to the bus bar, the electric conductor projecting from the winding head, the threaded bolt and/or the screw head. The advantage of this design is that it allows for a particularly uniform and efficient fluid cooling of the HV connecting elements.

The screw connection is arranged in the direction of gravity in a lower region of the housing, which can promote efficient and safe cooling by the cooling fluid.

The at least one electric conductor projecting from the winding head can project from the winding head in the axial direction or in the radial direction.

The stator according to the present disclosure is intended for use in an electric machine. The electric machine is used to convert electrical energy into mechanical energy and/or vice versa, and generally includes a stationary part, referred to as a stator, and a part referred to as a rotor, which is arranged movably, in particular rotatably, in relation to the stationary part.

The stator according to the present disclosure is configured for use in a radial flux machine.

In particular, the electric machine is dimensioned such that vehicle speeds of more than 50 km/h, such as more than 80 km/h, and in particular more than 100 km/h can be achieved. The electric motor particularly has an output of more than 30 kW, such as more than 50 kW, and in particular more than 70 kW. Furthermore, the electric machine provides rotational speeds greater than 5,000 rpm, particularly greater than 10,000 rpm, such as greater than 12,500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

A winding with conductors can particularly be embedded in the stator slots of the stator according to the present disclosure. A conductor is in particular an electrically conductive conductor with two conductor sections which run in parallel and include longitudinal extensions that are significantly larger than their diameters. In principle, the conductor sections can have any cross-sectional shape other than an annular shape. Rectangular cross-sectional shapes allow for high packing densities and consequently high power densities to be achieved. Particularly, a conductor is formed of copper. A conductor is insulated. To insulate the conductors, for example, mica paper, which for mechanical reasons can be reinforced by a glass fabric carrier, can be wound in tape form around one or more stator windings, which are impregnated by means of a curing resin. In principle, it is also possible to use a curable lacquer layer without mica paper to insulate a conductor.

The winding may be designed as a hairpin winding or wave winding. In this context, it is further the case that the conductors are designed as hairpin conductors.

The stator according to the present disclosure also has at least one stator body. The stator body can be made in one piece or in multiple pieces, in particular in a segmented manner. A one-piece stator body is characterized by the fact that the entire stator body is formed in one piece as viewed over the circumference. The stator body is usually formed from a plurality of stacked laminated electrical steel sheets, wherein each of the electrical steel sheets is closed to form an annular ring. A segmented stator body is characterized by the fact that it is constructed from individual stator segment parts. The stator body can be constructed from individual stator teeth or stator tooth groups, wherein each individual stator tooth or each individual stator tooth group can be formed from a plurality of stacked laminated electrical steel sheets, wherein each of the electrical steel sheets is designed as a stator segment lamination part.

The stator body may be formed from one or more stator laminated cores. A stator laminated core is understood to mean a plurality of laminated individual laminations or stator sheets, which are generally made from electrical steel sheets and are layered and packed one on top of the other to form a stack or what is referred to as a stator laminated core. The individual laminations can then remain held together in the laminated core by adhesive bonding, welding or screwing.

The stator teeth of the stator are formed in the stator body. Stator teeth are components of the stator body which are designed as circumferentially spaced, tooth-like parts of the stator body that are directed radially inward, with an air gap for the magnetic field being formed between the free ends of the stator teeth and a rotor body. The gap between the rotor and the stator is referred to as the air gap. In a radial flux machine, this is a substantially annular gap with a radial width that corresponds to the distance between the rotor body and the stator body.

According to an advantageous embodiment of the present disclosure, the plurality, such as all, of the electric conductors have a substantially rectangular contour in cross-section. The advantage of this design is that electric conductors that are generally available as standard can be used to form the stator winding, which is particularly favorable in terms of the manufacturing costs of the stator.

The function of the cooling fluid in the stator according to the present disclosure is to dissipate heat as efficiently as possible from regions of the stator that are heating up and to prevent these regions from overheating. In addition to this main task, the cooling fluid can in particular also provide lubrication and corrosion protection for the moving parts and/or the metal surfaces of the cooling system of the stator or the electric machine. In addition, it can, in particular, also remove contaminants (for example as caused by abrasion), water and air. The cooling fluid may be a liquid. The cooling fluid can, in particular, be an oil. In principle, however, it is also conceivable to use aqueous cooling fluids, for example also emulsions, such as water-glycol mixtures.

The cooling fluid of the stator can be connected to a hydraulic cooling system with a hydraulic cooling circuit. Such a hydraulic cooling system is used to dissipate the heat generated by electrical losses within an electric machine. Such a cooling system can have cooling channels within the rotor (rotor cooling channel) and/or stator (stator cooling channel), in particular also a flow through the stator slots, through which a corresponding cooling fluid is guided for the purpose of removing the heat.

The cooling fluid can particularly be pumped through the hydraulic circuit by means of a pump. In principle, it is conceivable to design a plurality of hydraulic circuits in order to cool the electric machine. In this case, the cooling channels of the stator may be connected to a hydraulic cooling circuit or to various cooling circuits of the cooling system. In particular, by connecting to several cooling circuits, it is possible to provide more precise cooling, since, for example, the temperature of the cooling fluid when entering the cooling channels of the stator, the flow velocity of the cooling fluid or even the type of cooling fluid (oil, emulsion) can be adjusted.

The stator slots may be closed by a slot-closure means so that the cooling fluid cannot flow from the stator slots into the air gap between the rotor and the stator. Particularly, the slot-closure means is a slot-closure wedge.

The hydraulic cooling system also particularly has a winding head cooling, by means of which the cooling fluid can be applied to at least one winding head, at least in sections.

The stator can be received in a motor housing which surrounds the stator or the electric machine. A motor housing can also receive the control and power electronics. The motor housing can furthermore be part of a cooling system for the electric machine, and can be designed such that cooling fluid can be supplied to the electric machine via the motor housing and/or the heat can be dissipated to the outside via the housing surfaces. In addition, the motor housing protects the electric machine and any electronics that may be present from external influences.

A motor housing can be formed in particular from a metallic material. Advantageously, the motor housing can be formed from a metallic cast material, such as die-cast aluminum, die-cast magnesium, gray cast iron, or cast steel.

The power electronics can be received in an inverter housing. The inverter housing can be formed from a metallic material, particularly from aluminum, gray cast iron or cast steel, in particular by means of a primary shaping process such as casting or die-casting. The inverter housing particularly has a pot-like spatial shape. In this context, the housing cover can be inserted into the pot-like inverter housing. Alternatively, it would also be conceivable for the housing cover to rest on the pot-like inverter housing and cover its opening.

The inverter housing can also be part of the motor housing or vice versa. This means that the inverter housing is formed completely or partially as integral, in particular monolithic, with the motor housing.

The power electronics received in the inverter housing can be provided in particular for an electric machine of an electrically operable drive train of a motor vehicle. The power electronics are a combination of different components that control or regulate a current to the electric machine of the axle drive train, including the peripheral components required for this purpose, such as cooling elements or power supply units. In particular, the power electronics contain one or more power electronics components that are configured to control or regulate a current. These are particularly one or more power switches, such as power transistors. The power electronics particularly have more than two, and particularly three, phases or current paths which are separate from one another and which each have at least one separate power electronics component. The power electronics can designed for controlling or regulating a power per phase with a peak power, a continuous power, of at least 100 W, at least 1000 W, and/or particularly at least 10000 W.

The power electronics may also have control electronics and/or sensor electronics for the electric axle drive train, for example an ACU. The power electronics module may have at least one motor current connection and/or one electric signal connection.

The electric axle drive train can be operated by means of the power electronics module, in that the power electronics module conducts current into the electrically operable axle drive train, e.g., to a stator winding of the electric machine.

Advantageous embodiments of the present disclosure are specified in the dependent claims. The features listed individually in the dependent claims can be combined with one another in a technologically meaningful manner and can define further embodiments of the present disclosure. In addition, the features indicated in the claims are specified and explained in more detail in the description, wherein further example embodiments of the present disclosure are shown.

According to an advantageous embodiment of the present disclosure, the screw head of the screw connection can be arranged within the housing and is connected in an electrically conductive manner to the at least one electric conductor of the stator winding projecting from the winding head, while the threaded bolt of the screw connection connected to the screw head projects from the base of the housing and the screw connection is locked by the nut. The advantage of this design is that it also makes it possible, for example, to dispense with the use of an additional bus bar by connecting the screw head directly to the electric conductor projecting from the winding head, for example by welding or soldering.

According to a further development of the present disclosure, the electric conductor of the stator winding projecting from the winding head can have a radially extending conductor section with a free end, which can be coupled to the connecting conductor via the screw connection, which can simplify the assembly of the screw connection. Depending on the design of the stator, however, the ends of the winding conductors can also be led out of the winding head only axially without additional bending being applied.

Furthermore, according to another advantageous embodiment of the present disclosure, a bus bar can extend within the housing, which connects the electric conductor of the stator winding projecting axially from the winding head to the screw connection. The advantage of this design is that the bus bar allows for an assembly-friendly contact of the electric conductor projecting axially from the winding head to be established and eliminates the need for additional bending of the conductor.

According to a further particular embodiment of the present disclosure, the bus bar can have an opening at which an internal thread is arranged, which is in engagement with the threaded bolt, wherein the internal thread may be formed on a threaded insert which is inserted into the opening. This, in particular, has the effect of allowing the threaded bolt to be screwed in from outside the housing with a screw head. The threaded bolt then engages through the opening in the base of the housing only when it is screwed into the internal thread. In the other embodiments, the threaded bolt engages through the opening and a nut is subsequently screwed onto the threaded bolt.

Furthermore, the present disclosure can also be further developed in such a way that the screw head has an outer contour that deviates from the annular shape, or the bus bar has an introduction contour that deviates from the annular shape, which engages in a form-fitting manner in a correspondingly formed opening in the base of the housing. The advantage of this design is that the threaded bolt is fixed in a non-rotatable manner with respect to the housing, which makes it easier to screw on the nut.

In a further embodiment of the present disclosure, the inner screw head can be fixed and sealed with respect to the housing by means of an adhesive connection, and/or the inner bus bar can be fixed and sealed with respect to the housing by means of an adhesive connection, and/or the inner threaded insert can be fixed and sealed with respect to the housing by means of an adhesive connection.

This means that no precise sealing surfaces are required to seal the opening extending through the housing, as the adhesive holds the corresponding components in position and seals them at the same time until final screw connection. The adhesive can be applied in the same process step as an adhesive for assembling the housing itself. This allows for the corresponding HV connecting elements to be positioned and fixed to the housing without any additional effort.

It can also be advantageous to further develop the present disclosure such that the electric conductor of the stator winding projecting axially from the winding head has an axially running conductor section with a free end to which the bus bar extending in the radial direction is electrically connected. The advantage of this is that the conductor does not need to be bent, which can have advantages in terms of production.

According to a further embodiment of the subject matter of the present disclosure, the base can have an opening which is penetrated at least in sections by an electric conductor of a temperature sensor, and the temperature sensor bears against the radially extending conductor section of the electric conductor of the stator winding projecting from the winding head or the bus bar.

This allows for any necessary or desired temperature sensor to be integrated directly into or onto the housing, bus bar, or conductor. It is also conceivable that the temperature sensor will only be positioned during or after the housing has been assembled. Advantageously, the temperature sensor is arranged directly on the bus bar or on the electric conductor projecting from the winding head, whereby a very accurate and fast-responding temperature sensor system can be provided.

The present disclosure can further include a method for producing a stator for an electric machine, in particular for an electric machine within a drive train of a motor vehicle, including the following steps:
providing a stator body having a plurality of stator teeth arranged in a distributed manner over the circumference and stator slots formed between the stator teeth and extending in the axial direction through the stator body, wherein in the stator slots electric conductors of a stator winding are arranged which emerge from the stator body at an end face at least forming a winding head, wherein during operation of the electric machine, a cooling fluid can be applied to the winding head, and at least one of the electric conductors of the stator winding projects from the winding head,
providing an annular housing for enclosing the winding head, wherein the housing has an annular-disc-like base and cylinder rings, extending axially therefrom,
providing a screw connection including a threaded bolt and a nut and/or a screw head connected to the threaded bolt and/or an internal thread arranged on a bus bar,
establishing an electric contact between the at least one electric conductor of the stator winding projecting from the winding head and the screw head or the bus bar,
axially sliding the housing over the winding head so that the housing seals the winding head with respect to the surroundings and to the stator body, and
establishing an electric contact between the electric conductor of the stator winding projecting from the winding head and a connecting conductor by means of the screw connection so that the threaded bolt of the screw connection engages through the base of the housing and the nut corresponding to the threaded bolt or the screw head connected on the threaded bolt outside the housing locks the screw connection with respect to the housing in such a way that the electric connecting conductor is fixed relative to the screw connection and a current path is established between the connecting conductor and the at least one electric conductor of the stator winding projecting from the winding head.

### BRIEF DESCRIPTION OF THE DRAWINGS

The present disclosure will be explained in more detail below with reference to figures without limiting the general concept of the present disclosure. In the figures:

FIG. 1 shows a first embodiment of a stator in a detailed axial sectional view,

FIG. 2 shows a top view of an exposed screw connection of the first embodiment of the stator,

FIG. 3 shows a second embodiment of a stator in a detailed view,

FIG. 4 shows a top view of an exposed screw connection of the second embodiment of the stator,

FIG. 5 shows a sectional view of the screw connection from FIG. 4,

FIG. 6 shows a third embodiment of a stator in a detailed axial sectional view,

FIG. 7 shows a top view of an exposed screw connection of the third embodiment of the stator,

FIG. 8 shows a sectional view of the screw connection from FIG. 7,

FIG. 9 shows a top view of an exposed screw connection with a temperature sensor and an associated sectional view in a first embodiment,

FIG. 10 shows a top view of an exposed screw connection with a temperature sensor and an associated sectional view in a second embodiment,

FIG. 11 shows an electric machine in a schematic axial sectional view,

FIG. 12 shows an electric machine in a schematic cross-sectional view,

FIG. 13 shows a schematic representation of a motor vehicle with an electrically operable drive train, and

FIG. 14 shows a fourth embodiment of a stator in an axial sectional view.

### DETAILED DESCRIPTION

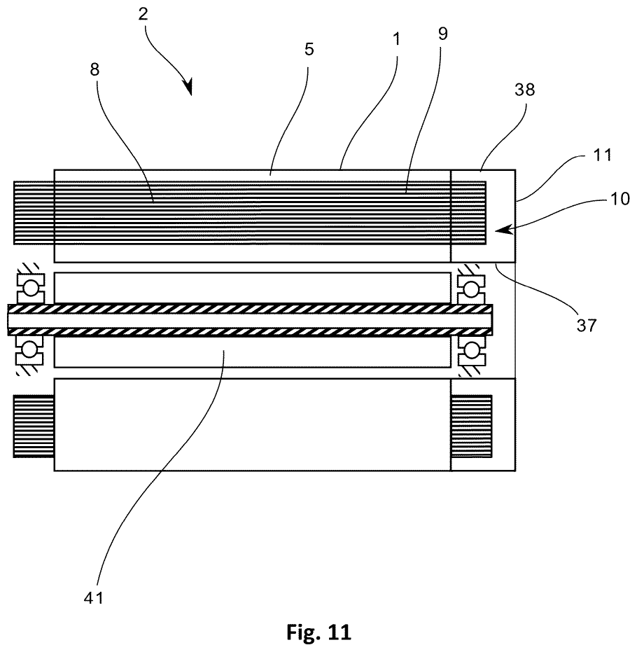

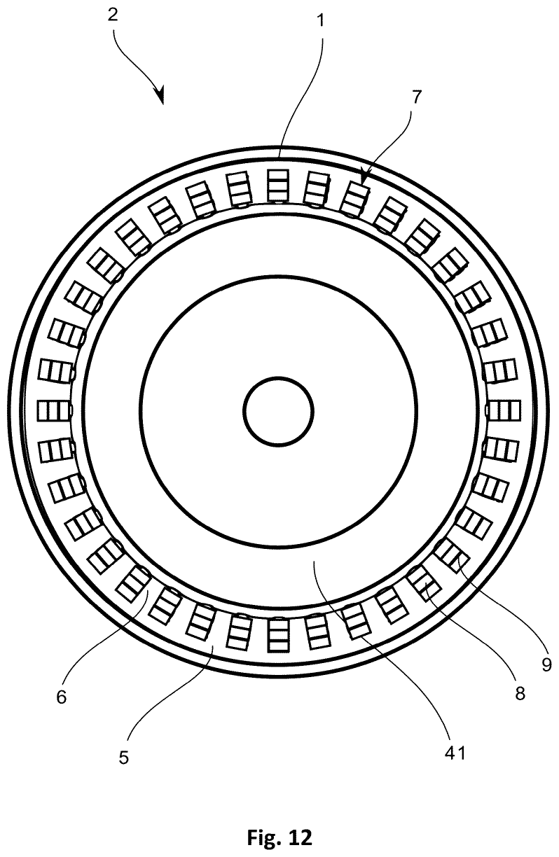

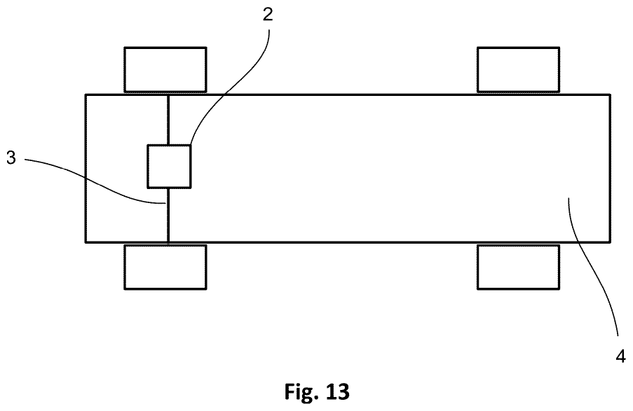

FIGS. 11-12 show a stator 1 for an electric machine 2 configured as a radial flux machine, in particular for an electric machine 2 within a drive train 3 of a motor vehicle 4, as also outlined in FIG. 13.

The hollow-cylindrical stator 1 has a stator body 5 with a plurality of stator teeth 6 arranged in a distributed manner over the circumference and stator slots 7 formed between the stator teeth 6 and extending in the axial direction through the stator body 5. The rotor 41 is mounted such that it can rotate within the stator 1.

Electric conductors 8 of a stator winding 9 are arranged in the stator slots 7 and emerge from the stator body 5 at an end face, at least forming a winding head 10. In order to cool this region, which is usually subject to high thermal loads, a cooling fluid 16, such as a cooling oil, can be applied to the winding head 10 during operation of the electric machine 2.

The winding head 10 is enclosed by an annular housing 11 which seals the winding head 10 with respect to the surroundings and to the stator body 5, wherein the housing 11 has an annular-disc-like base 14 and cylinder rings 37, 38 extending axially out of the base. This type of housing 11 is reminiscent of a bundt cake shape. The housing 11 is placed with its open end face against the end face of the stator body 5 so that the winding head 10 is substantially completely enclosed by the housing 11 and the cooling fluid 16 cannot escape uncontrolled from the housing 11 or the stator body 5 into the surroundings of the electric machine 2.

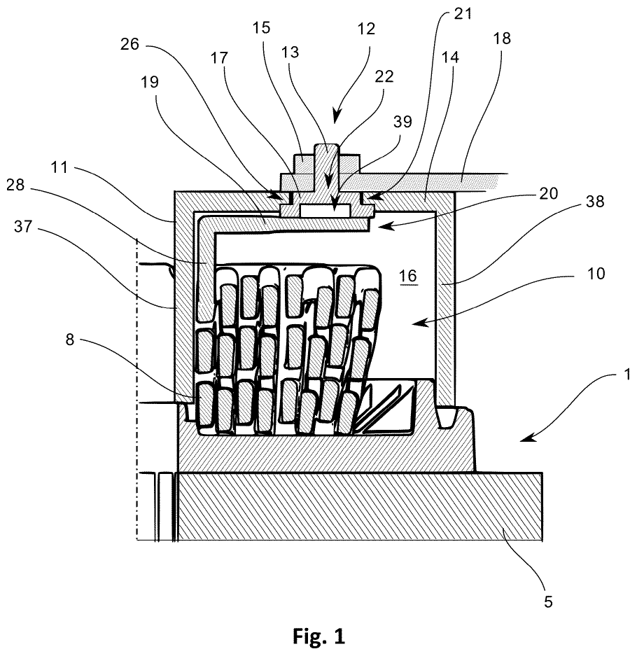

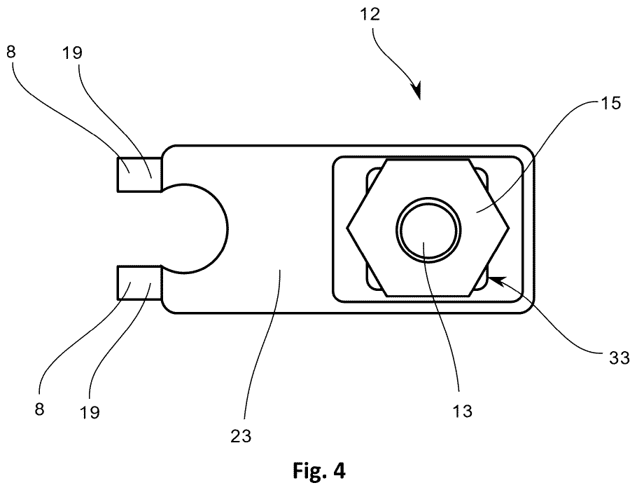

The electric contacting of the winding head 10 is now explained in more detail on the basis of FIGS. 1-10.

All of the design variants shown have in common that one of the electric conductors 8 of the stator winding 9 protrudes axially from the winding head 10 and is connected in an electrically conductive manner to a screw connection 12, the threaded bolt 13 of which engages through the base 14 of the housing 11.

Depending on the design alternative, a nut 15 corresponding to the threaded bolt 13 or a screw head 17 connected on the threaded bolt 13 may be provided to form the screw connection 12, wherein the nut 15 or the screw head 17 is arranged outside the housing 11. The screw connection 12 can now be locked with respect to the housing 11 in such a way that an electric connecting conductor 18 can be fixed with respect to the screw connection 12 and a current path can be established between the connecting conductor 18 and the at least one electric conductor 8 of the stator winding 9 projecting axially from the winding head 10.

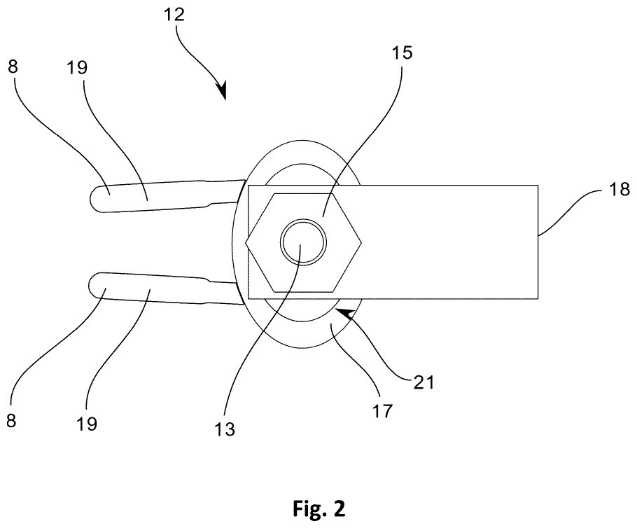

FIGS. 1-2 show a first embodiment of the screw connection 12, in which the screw head 17 of the screw connection 12 is arranged within the housing 11 and is connected in an electrically conductive manner to the at least one electric conductor 8 of the stator winding 9 projecting axially from the winding head 10, while the threaded bolt 13 of the screw connection 12 connected to the screw head 17 projects from the base 14 of the housing 11 and the screw connection 12 is locked by the nut 15. The rotary movement for locking the screw connection is therefore effected by turning the nut 15.

In the example shown in FIG. 1, the electric conductor 8 of the stator winding 9 projecting axially from the winding head 10 has a radially extending conductor section 19 with a free end 20 which can be coupled to the connecting conductor 18 via the screw connection 12.

As can be seen on the basis of FIG. 1, the screw head 17 can also have a recess 39 in the contact region with the conductor 8, whereby the cooling effect can be improved, in particular if the conductor 8 has an opening aligned with the recess 39 through which the cooling fluid 16 can enter directly into the recess 39. In this regard, the recess 39 can increase the surface area exposed to the cooling medium, which can contribute to good cooling of the screw connection point. Furthermore, the recess 39 can also contribute to material and weight savings.

The threaded bolt 13 and the screw head 17 are monolithically formed as a cold-formed part, thus forming a one-piece screw which is joined to the bent electric conductor 8, for example by welding. Here, the recess 39 can provide material for forming the geometry during cold pressing.

FIG. 2 clearly shows that the screw head 17 has an oval outer contour 21 that deviates from the annular shape, which engages in a corresponding oval opening 22 in the base 14 of the housing 11 in a form-fitting manner, so that the nut 15 can be rotated securely without the screw head 17 turning, as the screw head 17 is supported accordingly on the base 14 of the housing 11. The inner screw head 17 is fixed and sealed with respect to the housing 11 by means of an adhesive connection 26.

The screw head 17 thus fits in a form-fitting manner into a corresponding opening 22 in the housing 11, which is provided with a shoulder extending circumferentially in order to provide the necessary surface area for the adhesive of the adhesive connection 26. The adhesive can be applied to the housing 11 in the same process as an adhesive for joining the housing 11 to the stator body 5, for example. During curing, the threaded bolt 13 of the “screw” can be used to press the “screw” against the housing 11, for example by screwing a suitable mounting aid plate in place of the connecting conductor 18. The adhesive of the adhesive connection 26 then primarily performs a sealing and positioning function and only when the electric feed connection conductor 18 is screwed on does a mechanically robust connection form, through which, for example, any forces occurring during operation of the electric machine 2 due to vibrations, etc., are completely received by the housing 11.

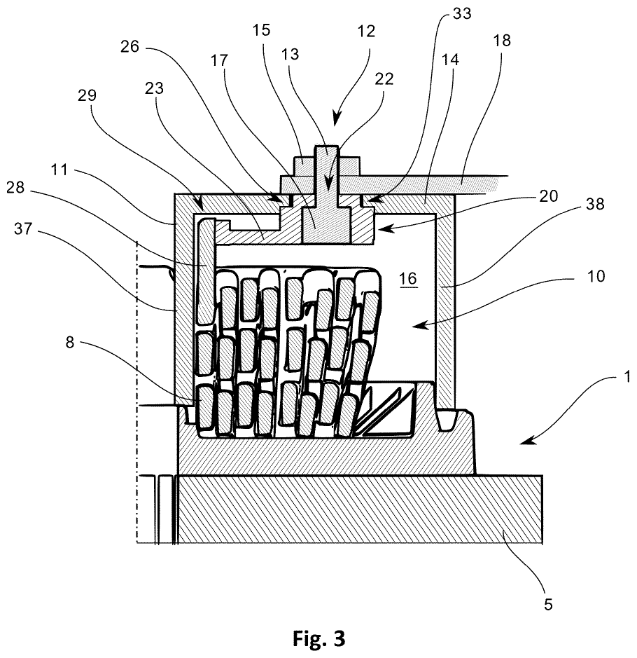

FIGS. 3-8 show embodiments of the screw connection 12, in which a bus bar 23 extends within the housing 11 and connects the electric conductor 8 of the stator winding 9 projecting axially from the winding head 10 to the screw connection 12. FIG. 3 shows an embodiment in which the electric conductor 8 of the stator winding 9 projecting axially from the winding head 10 has an axially running conductor section 28 with a free end 29 to which the bus bar 23 extending in the radial direction is electrically connected.

FIG. 3 therefore shows a variant in which the electric conductor 8 projecting axially from the winding head does not need to be bent, which is more in line with conventional winding joining processes. It does not matter in this regard whether the winding ends of the corresponding conductor 8 are located on the inner diameter, on the outer diameter or between them. The bus bar 23 can be easily produced as a stamped/formed part and can be relatively thin, as it is located in the space of the cooling fluid 16. In the bus bar 23, a screw, formed monolithically from the threaded bolt 13 and the screw head 17, is inserted into the bus bar 23 and held in a rotationally secure manner, for example by means of a press fit and by means of a form fit.

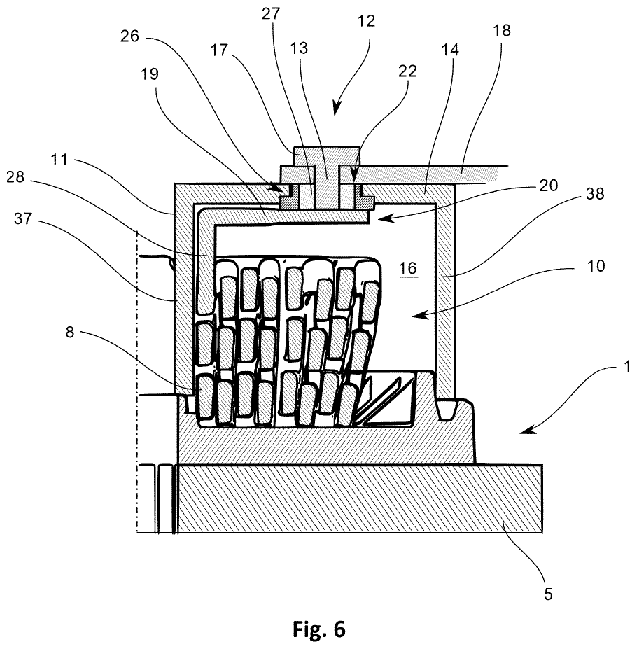

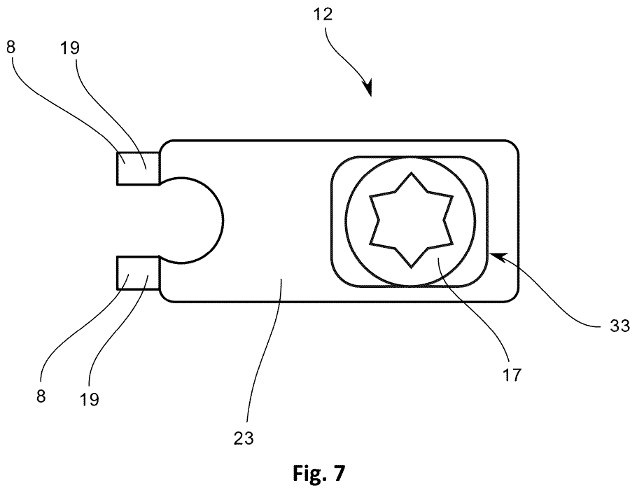

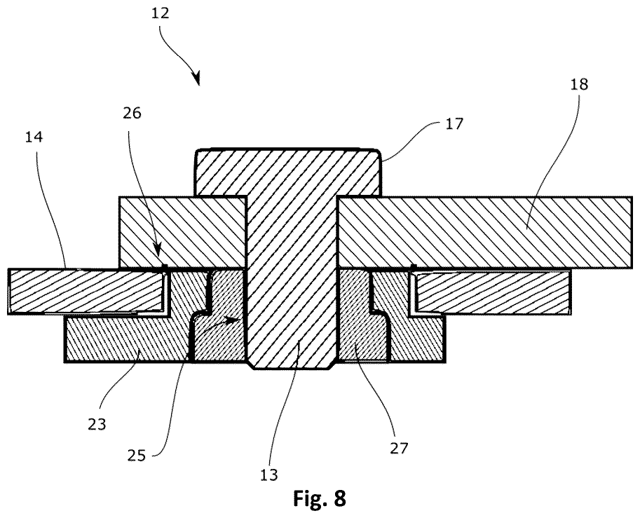

As shown in FIGS. 6-8, the bus bar 23 can have an opening 24 at which an internal thread 25 is arranged, which is in engagement with the threaded bolt 13, wherein the internal thread 25 is formed on a threaded insert 27 which is inserted into the opening 24. Naturally, it would also be possible in principle to form the internal thread 25 directly on or in a corresponding conductor 8 of the stator winding 9, but this is not shown in the figures. The inner threaded insert 27 can be fixed and sealed with respect to the housing 11 by means of an adhesive connection 26, as shown in FIG. 8. In this regard, the adhesive connection 26 is arranged on the bus bar 23, which carries the threaded insert 27. The adhesive of the adhesive connection 26 is then located in a circumferential ring channel which has an L-shaped contour in cross-section, which can also be clearly seen in FIG. 8. Since all contact surfaces are made of copper on at least one side, the necessary tightness between the threaded bolt 13 and the internal thread 25 can also be achieved by the screwing process. Another advantage of this embodiment is that, as shown in FIG. 7, a hexalobular drive can be used to screw the screw head 17, thus requiring very little installation space.

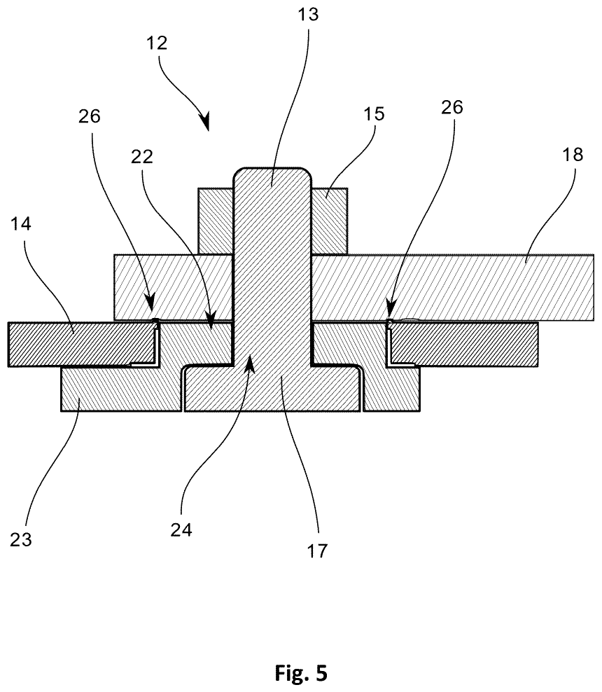

The bus bar 23 in the embodiments shown in FIGS. 3-8 has a rectangular introduction contour 33 that deviates from the annular shape and engages in a form-fitting manner in a correspondingly formed rectangular opening 22 in the base 14 of the housing 11. The inner bus bar 23 is fixed and sealed with respect to the housing 11 by means of an adhesive connection 26, which can be seen particularly well on the basis of the detailed representations in FIG. 5. The circumferential channels, which are L-shaped in cross-section and are used for receiving the adhesive of the adhesive connection 26, can be clearly seen.

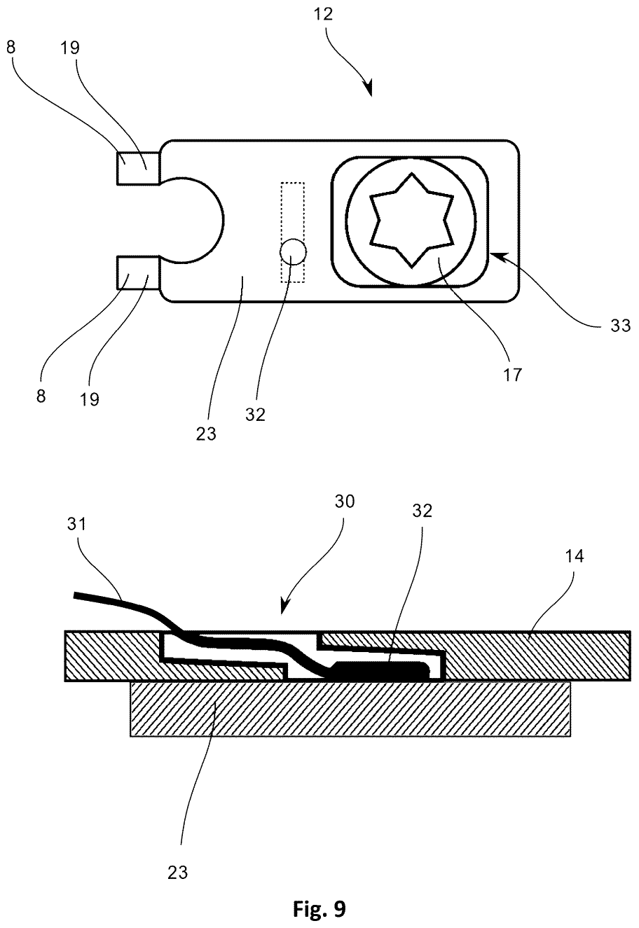

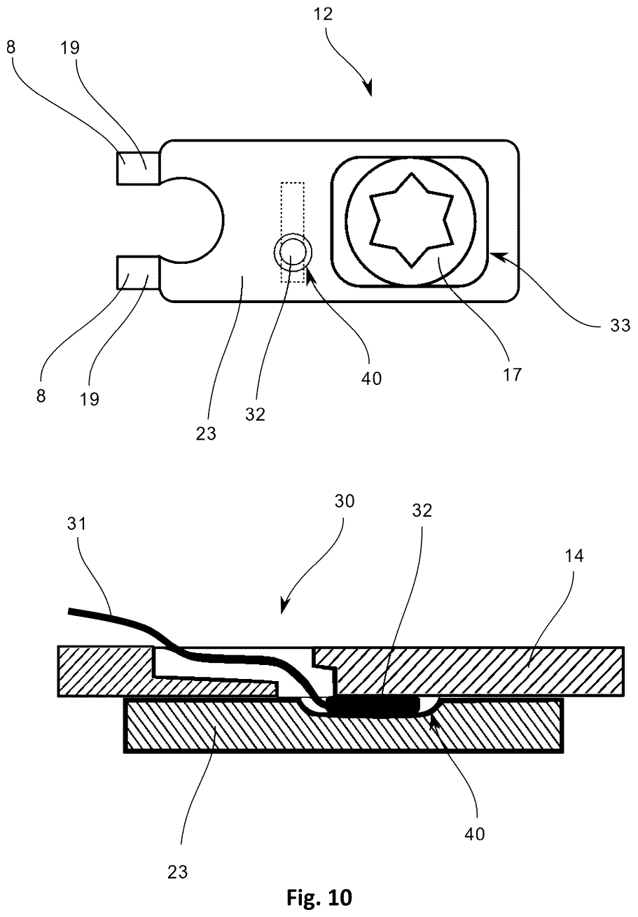

FIGS. 9-10 show embodiments of the stator 1 in which a temperature sensor 32 has been integrated in the region of the screw connection 12. The base 14 has an opening 30 which is penetrated at least in sections by an electric conductor 31 of a temperature sensor 32, and the temperature sensor 32 bears against the radially extending conductor section 19 of the electric conductor 8 of the stator winding 9 projecting axially from the winding head 10 or the bus bar 23.

This allows the temperature sensor 32 to be bonded directly to the conductor section 19 or the bus bar 23 from the outside, integrated into the housing 11. This can be done in the same process step as the bonding of an HV connecting element in the housing 11, as already explained. A major advantage of this embodiment is that the temperature sensor 32 does not have to be mounted on the stator winding 9 in a separate step and no additional cable has to be routed through the housing 11 and sealed. Nevertheless, the temperature is measured at a conductor section 19 or the bus bar 23 which is surrounded by the cooling fluid 16 on at least one side. This means that, by controlling the operation of the electric machine accordingly, the adhesive connection 26 and the housing 11 made of plastic in particular can be protected against excessive temperatures.

Furthermore, the temperature sensor 32 is not surrounded by the cooling fluid 16 on any side, but is relatively well thermally insulated on the “free” side by the adhesive and the housing 11. This effectively eliminates environmental influences and measures the actual temperature of the HV connecting element (usually made of copper).

As shown in FIG. 10, as a further idea, the bus bar 23 or the electric conductor 8 projecting axially from the winding head can have a recess 40 which is formed as only slightly larger than the temperature sensor 32 and in which the temperature sensor 32 is mounted in a recessed manner, which can contribute to an improved temperature measurement. In order to further improve the temperature measurement, the cavities between the temperature sensor 32 and the bus bar 23, the conductor 8 and/or the housing 11 can be filled with a heat-conducting paste.

The adhesive compound then primarily serves to seal and fix the electric conductor 31. The bus bar 23 or the electric conductor 8 projecting axially from the winding head can also be designed such that the cross-section in the contact region with the temperature sensor 32 is comparable to the cross-section of the winding wire in order to achieve comparable heating and thus a representative temperature at the temperature sensor 32.

In order to produce a stator 1 as shown in FIGS. 1-10, the following method can be used. First, a stator body 5 is provided, having a plurality of stator teeth 6 arranged in a distributed manner over the circumference and stator slots 7 formed between the stator teeth 6 and extending in the axial direction through the stator body 5, wherein in the stator slots 7 electric conductors 8 of a stator winding 9 are arranged which emerge from the stator body 5 at an end face at least forming a winding head 10, wherein during operation of the electric machine 2, a cooling fluid 16 can be applied to the winding head 10, and at least one of the electric conductors 8 of the stator winding 9 projects axially from the winding head 10. An annular housing 11 is also provided for enclosing the winding head 10, wherein the housing 11 has an annular-disc-like base 14 and cylinder rings 37, 38 extending axially therefrom, and a screw connection 12 is provided including a threaded bolt 13 and a nut 15 and/or a screw head 17 connected to the threaded bolt 13 and/or an internal thread 25 arranged on a bus bar 23.

Then, an electric contact is first established between the at least one electric conductor 8 of the stator winding 9 projecting axially from the winding head 10 and the screw head 17 or the bus bar 23, for example by welding or soldering.

The housing 11 is then slid axially over the winding head 10 so that the housing seals the winding head 10 with respect to the surroundings and to the stator body 5.

After sliding on the housing 11, an electric contact can then be established between the electric conductor 8 of the stator winding 9 projecting axially from the winding head 10 and a connecting conductor 18 by means of the screw connection 12 so that the threaded bolt 13 of the screw connection 12 engages through the base 14 of the housing 11 and the nut 15 corresponding to the threaded bolt 13 or the screw head 17 connected on the threaded bolt 13 outside the housing 11 locks the screw connection 12 with respect to the housing 11 in such a way that the electric connecting conductor 18 is fixed relative to the screw connection 12 and a current path is established between the connecting conductor 18 and the at least one electric conductor 8 of the stator winding 9 projecting axially from the winding head 10.

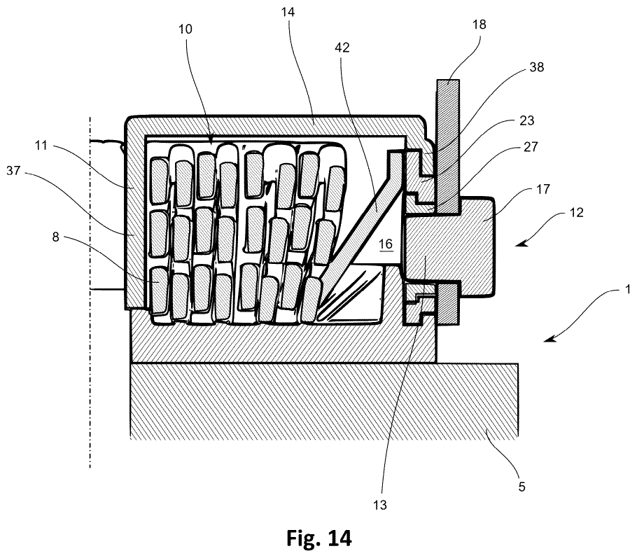

FIG. 1, FIG. 3 and FIG. 6 show embodiments of a stator 1 in which at least one electric conductor 8 extends axially out of the winding head 10 and is connected in an electrically conductive manner to the connecting conductor 18 by means of a screw connection 12. FIG. 14 shows an embodiment in which the electric conductor extends radially out of the winding head 10. In this case, the screw connection 12 is no longer positioned in the base 14 of the housing 11, but in the radially outer cylinder ring 38. The electric conductor 8 projecting radially from the winding head 10 has a conductor section 42 which extends in a ramp-like manner in both the radial and axial directions from the winding head towards the radially outer cylinder ring 38 and is connected in an electrically conductive manner to the bus bar 23 with its free end. The conductor section 41 can have a spring force acting in the radial direction, which simplifies the electric contact and the assembly of the housing 11. It is to be understood that the screw connections 12 shown in the other exemplary embodiments are also transferable to the embodiment of FIG. 14.

The present disclosure is not limited to the embodiments shown in the figures. The above description is therefore not to be regarded as limiting, but rather as illustrative. The following claims are to be understood as meaning that a stated feature is present in at least one embodiment of the present disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Stator
2 Electric machine
3 Drive train
4 Motor vehicle
5 Stator body
6 Stator teeth
7 Stator slots
8 Conductor
9 Stator winding
10 Winding head
11 Housing
12 Screw connection
13 Threaded bolt
14 Base
15 Nut
16 Cooling fluid
17 Screw head
18 Connecting conductor
19 Conductor section
20 End
21 Outer contour
22 Opening
23 Bus bar
24 Opening
25 Internal thread
26 Adhesive connection
27 Threaded insert
28 Conductor section
29 End
30 Opening
31 Conductor
32 Temperature sensor
33 Introduction contour
37 Cylinder ring
38 Cylinder ring
39 Recess
40 Recess
41 Rotor
42 Conductor section

1. A stator for an electric machine, comprising:
a stator body having a plurality of stator teeth arranged in a distributed manner over a circumference of the stator body and stator slots formed between the stator teeth and extending in an axial direction through the stator body,
a stator winding in the stator slots and comprising electric conductors being arranged, which emerge from the stator body at an end face, at least forming a winding head,
during operation of the electric machine, a cooling fluid is applied to the winding head, and
a housing which encloses the winding head and which seals the winding head with respect to surroundings and to the stator body, the housing having an annular-disc-like base and cylinder rings extending axially out of the base, wherein
at least one of the electric conductors of the stator winding projects out of the winding head and is connected in an electrically conductive manner to a bolt connection, a threaded bolt of which engages through the base of the housing and a nut corresponding to the threaded bolt or a bolt head connected on the threaded bolt outside the housing locks the bolt connection with respect to the housing in such a way that an electric connecting conductor is fixed relative to the bolt connection and a current path is established between the electric connecting conductor and the at least one electric conductor of the stator winding projecting from the winding head.

2. The stator according to claim 1, wherein
the bolt head of the bolt connection is arranged within the housing and is connected in an electrically conductive manner to the at least one electric conductor of the stator winding projecting from the winding head, while the threaded bolt of the bolt connection connected to the bolt head projects from the base of the housing and the bolt connection is locked by the nut.

3. The stator according to claim 1, wherein
the at least one electric conductor of the stator winding projecting from the winding head has a conductor section with a free end coupled to the electric connecting conductor via the bolt connection.

4. The stator according to claim 1, further comprising
a bus bar extending within the housing and connects the electric conductor of the stator winding projecting from the winding head to the bolt connection.

5. The stator according to claim 4, wherein
the bus bar has an opening at which an internal thread is arranged, and which is in engagement with the threaded bolt, wherein the internal thread is formed on a threaded insert which is inserted into the opening.

6. The stator according to claim 4, wherein
the bolt head has an outer contour that deviates from an annular shape, or the bus bar has an introduction contour that deviates from an annular shape, which engages in a form-fitting manner in a correspondingly formed opening in the base of the housing.

7. The stator according to claim 4, wherein at least one of
the bolt head is fixed and sealed with respect to the housing by an adhesive connection,
the bus bar is fixed and sealed with respect to the housing by an adhesive connection, or
the threaded insert is fixed and sealed with respect to the housing by an adhesive connection.

8. The stator according to claim 4, wherein
the electric conductor of the stator winding projecting from the winding head has an axially running conductor section with a free end to which the bus bar extending in a radial direction is electrically connected.

9. The stator according to claim 4, wherein
the base has an opening which is penetrated at least in sections by an electric conductor of a temperature sensor, and the temperature sensor bears against a conductor section of the electric conductor of the stator winding projecting from the winding head or the bus bar.

10. A method for producing a stator for an electric machine, comprising:
providing a stator body having a plurality of stator teeth arranged in a distributed manner over a circumference and stator slots formed between the stator teeth and extending in an axial direction through the stator body, wherein in the stator slots, electric conductors of a stator winding are arranged which emerge from the stator body at an end face at least forming a winding head, wherein during operation of the electric machine, a cooling fluid is applied to the winding head, and wherein at least one of the electric conductors of the stator winding projects from the winding head;
providing housing enclosing the winding head, the housing having an annular-disc-like base and cylinder rings extending axially therefrom;
providing a bolt connection comprising a threaded bolt and at least one of a nut coupled to the threaded bolt, a bolt head connected to the threaded bolt, or an internal thread arranged on a bus bar coupled to the threaded bolt;
establishing an electric contact between the at least one of the electric conductors of the stator winding projecting from the winding head and the bolt head or the bus bar;
axially sliding the housing over the winding head so that the housing seals the winding head with respect to surroundings and to the stator body; and
establishing an electric contact between the electric conductor of the stator winding projecting from the winding head and an electric connecting conductor by the bolt connection so that the threaded bolt of the bolt connection engages through the base of the housing and the nut or the screw head outside the housing locks the screw connection with respect to the housing in such a way that the electric connecting conductor is fixed relative to the screw connection and a current path is established between the electric connecting conductor and the at least one of the electric conductors of the stator winding projecting from the winding head.

11. The method according to claim 10, wherein the stator is within a drive train of a motor vehicle.

12. The stator according to claim 1, wherein the stator is part of a drive train of a motor vehicle.
